(19) United States
(12) Patent Application Publication
(10) Pub. No.: US 2017/0297930 A1
(43) Pub. Date: Oct. 19, 2017

(54) METHOD FOR TREATING WASTEWATER

(71) Applicant: XYLEM IP MANAGEMENT S.À R.L., Senningerberg (LU)

(72) Inventors: Alexis De Kerchove, Bromma (SE); Alan Merry, Basingstoke Hampshire (GB)

(73) Assignee: XYLEM IP MANAGEMENT S.À R.L., Senningerberg (LU)

(21) Appl. No.: 15/516,247

(22) PCT Filed: Sep. 28, 2015
(86) PCT No.: PCT/IB2015/057423

§ 371 Date: Mar. 31, 2017

(30) Foreign Application Priority Data
Oct. 2, 2014 (SE) 1451169-5

(51) Int. Cl. C02F 1/52; C02F 3/12; C02F 103/00; C02F 101/10

(52) U.S. Cl. CPC C02F 1/5209; C02F 3/1215; C02F 3/1263; C02F 1/5245; C02F 2209/14; C02F 2103/005; C02F 2103/001; C02F 2101/105; C02F 2209/16; C02F 2209/18; C02F 2209/40; C02F 2103/002

(57) ABSTRACT

A method for treating wastewater by using a coagulant that aggregates a phosphorus-containing substance. The method includes executing a reaction phase having a biological treatment phase and a subsequent chemical treatment phase. The chemical treatment phase includes the first substep of mixing the wastewater while injecting a predetermined dose of the coagulant into the basin in order for the coagulant to contact and coagulate the phosphorus-containing substances. The injection of the dose of the binding compound into the basin is performed during a time period equal to or more than a time period required to accomplish two mixing turnovers of the wastewater and equal to or less than a time period required to accomplish seven mixing turnovers of the wastewater. The second substep includes mixing the wastewater in order to flocculate the coagulated substance.

### TECHNICAL FIELD OF THE INVENTION

The present invention relates generally to the field of wastewater treatment. Further, the present invention relates specifically to a method for treating wastewater by using a binding compound to aggregate a phosphorus-containing substance present in said wastewater, wherein the binding compound comprises a coagulant.

### BACKGROUND OF THE INVENTION

Large volumes of municipal wastewater are generated on daily basis. Here, the omnibus term municipal wastewater encompasses blackwater, greywater as well as surface runoff. The generated municipal wastewater typically contains considerable amounts of pollutants such as phosphorus that originates, among others, from the use of various detergents. Average value for phosphorus concentration in the wastewater across EU is in the range 4-10 mg/L. Corresponding value in the USA is approximately 4-15 mg/L. In order to minimize its environmental impact the wastewater needs to be suitably treated prior to discharge to bodies of water such as lakes and ponds. Accordingly, the wastewater is normally processed in a wastewater treatment plant where the pollutants, including the phosphorus-containing compounds, are to the greatest possible extent removed from the liquid.

These wastewater treatment plants most often comprise mechanical treatment systems, which use natural processes within a constructed environment. Such a mechanical treatment system typically involves a so called activated sludge process where air and various reactants are added to the wastewater. A conventional activated sludge (CAS) process requires a plurality of receiving tanks, hosting different stages of the wastewater treatment. Hence, the processes of a reactant contacting phosphorus and creation of a precipitate normally take place in different tanks. On the other hand, the process of the precipitate settling into sludge is frequently combined with the process of disposing of the sludge. More particularly, the settling process, typically executed in a funnel-shaped settling tank, involves gravity-promoted sinking of the sludge and its immediate evacuation via bottom section of the tank.

A further, structurally different, type of the activated sludge process is a Sequential Batch Reactor (SBR) process. In an SBR-process, all treatment is done in a single basin. In this context, in an SBR-process all sludge is not instantaneously removed from the basin. Rather, a sludge layer is allowed to build at the bottom of the multi-purpose basin. In addition to reducing the footprint, the use of the SBR-process also simplifies day-to-day operations and operational changes and facilitates process control. Due to these benefits the SBR-process has been extensively used in Europe and the United States in the past two decades.

WO2012141895 discloses methods and additives for removing inorganic and organic target materials from phosphorus-containing water streams. Within this context an experiment (Example 5) performed in laboratory environment, and not in a full-scale treatment plant, is disclosed in which wastewater influent is treated utilizing CeCl₃. Hence, the inspected sample consists of the influent and does not originate from the basin containing process liquor. Moreover, by way of experiment, the settling phase of an actual waste water treatment process has been replaced by a filtering phase by means of a very fine filter with pore size of 0.20 μm, said filter being known to remove much more particles from the liquid than the conventional settling. Accordingly, the disclosed experiment cannot be representative for a real-life process of wastewater treatment such as any of the above-discussed CAS or SBR. In the same context, the mixing phase of the test is of long duration, lasting 16 hours. Clearly, processes having such a prolonged mixing phase aren't compatible with current requirements of the water treatment industry as regards process performance.

### OBJECT OF THE INVENTION

The present invention aims at obviating the aforementio-ned disadvantages and failings of previously known methods, and at providing an improved method for treating wastewater while leveraging benefits of the SBR-process. A primary object of the present invention is to provide an improved method of the initially defined type which enables more efficient removal of phosphorus from the wastewater.

Another object of the present invention is to provide a method which achieves a reduction of the amount of chemical reactants used in the removal process.

A further object of the present invention is to provide a method which achieves a reduction of the amount of sludge produced.

Yet another object of the present invention is to provide a method that may be employed on an industrial scale.

### SUMMARY OF THE INVENTION

According to the invention at least the primary object is attained by means of the initially defined method for treating wastewater having the features defined in the independent claim. Preferred embodiments of the present invention are further defined in the dependent claims.

Hence, according to the present invention, there is provided a method for treating wastewater in a basin by using a binding compound to aggregate a phosphorus-containing substance present in said wastewater, wherein the binding compound comprises a coagulant. Said method comprises at least the step of:
executing a reaction phase in the basin, said reaction phase comprising a biological treatment phase and a subsequent chemical treatment phase, the chemical treatment phase comprising the substeps of:
a) mixing the wastewater while injecting a predetermined dose of the binding compound into the basin, the binding compound being injected at a location in which the speed of the wastewater is equal to or more than 0.5 m/s in order for the binding compound to contact and coagulate the phosphorus-containing substances, wherein the injection of the dose of the binding compound into the basin (1) is performed during a time period equal to or more than a time period required to accomplish two mixing turnovers of the wastewater (5) and equal to or less than a time period required to accomplish seven mixing turnovers of the wastewater (5),
b) mixing the wastewater such that an average speed of the wastewater in the basin is equal to or more than 0.1 m/s and equal to or less than 0.4 m/s, in order to flocculate the coagulated phosphorus-containing substance.

Thus, the present invention is based on the insight that if the binding compound is to coagulate the phosphorus-containing substances with the improved effect as regards removal of phosphorus and given a customary high initial reactivity of the binding compound, then said compound needs to without delay contact the wastewater to a maximum possible extent. For that reason the wastewater needs to move at a higher speed when the binding compound is introduced in the basin. Still with reference to substep a), in order to ensure sufficient and substantially uniform distribution of the binding compound with the coagulant throughout the wastewater, the speed of the wastewater needs to be equal to or more than 0.5 m/s.

With reference to substep b), the coagulated particles are subsequently allowed to flocculate and build clumps. The wastewater moves at a lower speed. Accordingly, the mixing is gentle. This keeps the particles suspended and promotes flocculation without the risk of disunifying the growing flocs.

The superior coagulant distribution and particle flocculation properties of the method open for reduction of the amount of chemical reactants used in the removal process.

In a preferred embodiment, the dose of the binding compound is dependent on the concentration of phosphorus-containing substances to be coagulated during the chemical treatment phase and is determined based on a concentration of nitrogen-containing substances in the influent wastewater (C_{NH4 influent}) and based on the level of biodegradable carbon in the basin. More particularly, it has been established that the phosphorus concentration in the influent wastewater is correlated with the concentration of nitrogen-containing substances in the influent wastewater. Taking into account the level of biodegradable carbon in the basin further improves the accuracy of the dosing. In this context, the level of biodegradable carbon may be expressed in terms of total organic carbon (TOC), chemical oxygen demand (COD), carbonaceous biological oxygen demand, biological oxygen demand (BOD) or specific wavelength absorbance or transmittance. In particular, COD and BOD are easily measured whereas TOC can only be determined in a laboratory. By determining the level of biodegradable carbon in the basin, it may be computed how much carbon was consumed by bacteria in the biological treatment phase. This permits to infer the amount of phosphorus consumed by bacteria in the biological treatment phase. Hereby, it is indirectly determined how much phosphorus remains in the liquor at the onset of the chemical treatment phase. This measure improves the accuracy of the dosing in the subsequent chemical treatment phase. In this context, the consumed amount of carbon is relatively stable and is mainly temperature-dependent. This consumed amount of carbon may be directly measured, calculated based on historic process data or set for a limited time period (week, month) based on a random sample.

In a closely related embodiment discussed in Example 3, the correlation between the phosphorus concentration of the influent wastewater (C_{P, influent}) and the concentration of ammonium of the influent wastewater (C_{NH4, influent}) is equal to or less than 1:2 and equal to or more than 1:8, preferably equal to or less than 1:4 and equal to or more than 1:6, most preferably about 1:5. In this context, the correlation 1:5 is to be found in most EU-countries. In a variant, also thoroughly described in Example 3, Total Kjeldahl Nitrogen (TKN) may be used instead of ammonium, or another suitable measure of the total nitrogen-containing substances. Correctly determining the dosing regime is inter alia dependent on the phosphorus concentration of the influent wastewater. This process parameter has historically been very difficult to determine in a simple manner. Based on the insight that the phosphorus concentration of the influent wastewater (C_{P, influent}) and the ammonium concentration of the influent wastewater (C_{NH4, influent}) are directly correlated and that ammonium concentration is easily measured by means of a readily available sensor, the phosphorus concentration in the influent water may be straightforwardly determined. Above correlation has been further investigated in experiments using municipal wastewater from different sites as direct influent to a basin of the SBR. As stated above, the experiments are more thoroughly discussed in conjunction with Example 3.

In yet another preferred embodiment, phosphorus concentration of the liquid in the chemical treatment phase (C_{P, chemical}) is determined by subtracting target phosphorus concentration in the effluent (C_{P,target,effluent}) and phosphorus concentration in the biological treatment phase (C_{P, biological}) from phosphorus concentration in the influent (C_{P, influent}) in which (C_{P,target,effluent}) is the target level of the phosphorus concentration of the effluent wastewater and (C_{P, biological}) is a concentration reflecting phosphorus uptake (Pᵤₚₜₐₖₑ) during the biological treatment phase. The target level may be inferred using historical data or it may be imposed by the legislator. Regardless, once said level has been set, it is possible to arrive at a theoretical value for an accurate phosphorus concentration of the liquid in the chemical treatment phase (C_{P, chemical}). The dosing regime is then adjusted accordingly.

In a further embodiment, the method comprises executing a settling phase, allowing the flocculated phosphorus-containing substances to settle in the basin such that clear wastewater is obtained at the top of the basin and an activated sludge layer is formed at the bottom of the basin. Here and when used in an SBR-process, the specific benefits of the multi-purpose basin are leveraged to improve method results. More specifically, the inherent sludge layer at the bottom of the multi-purpose basin is only gradually replaced. Hence, the average time a given portion of the sludge spends in the basin varies between 15 and 25 days. Moreover, there are coagulants that preserve a certain level of reactivity also when bound to the phosphorus-containing substance and settled in the activated sludge layer. Obviously, the process of these coagulants binding to the phosphorus-containing substances may then be continued in the sludge layer. The removal of phosphorus is hereby conducted more efficiently than in the initially described, conventional CAS-process.

In a preferred embodiment, the coagulant is cerium trichloride (CeCl₃). Use of cerium trichloride may reduce the amount of the injected coagulant by up to 30% compared to other frequently employed coagulants. This depends at least partly on the fact that cerium trichloride is extremely reactive during first few seconds of its contact with the influent wastewater. Given the mixing speed used, cerium trichloride becomes thoroughly and uniformly distributed throughout the wastewater during its period of high reactivity. Moreover, cerium trichloride is a coagulant that preserves a certain level of reactivity also when bound to the phosphorus-containing substance and settled in the activated sludge layer.

Further advantages with and features of the invention will be apparent from the other dependent claims as well as from the following detailed description of preferred embodiments.

### BRIEF DESCRIPTION OF THE DRAWINGS

A more complete understanding of the abovementioned and other features and advantages of the present invention will be apparent from the following detailed description of preferred embodiments in conjunction with the appended drawings, wherein:

FIG. 1 is a schematic cross sectional side view of a multi-purpose basin suitable for a SBR-process with continuous inflow of influent, during a chemical treatment phase wherein the coagulant is being injected into the basin,

FIG. 2 is a schematic cross sectional side view of a structurally simple basin, during a chemical treatment phase wherein the coagulant is being injected into the basin,

FIG. 3 is a schematic cross sectional side view of a multi-purpose basin suitable for a SBR-process with continuous inflow of influent, during a chemical treatment phase, wherein phosphorus-containing substances are flocculating,

FIG. 4 is a schematic cross sectional side view of a multi-purpose basin suitable for a SBR-process with continuous inflow of influent, during a chemical treatment phase, wherein the flocculated matter has settled and decantation/extraction is in progress,

FIGS. 5-7 show correlation of the concentrations of nitrogen-based compounds and total phosphorus in municipal wastewater of Stockholm (Sweden), Cochranton (PA, USA) and El Monte (Chile), respectively.

### DETAILED DESCRIPTION OF PREFERRED EMBODIMENTS OF THE INVENTION

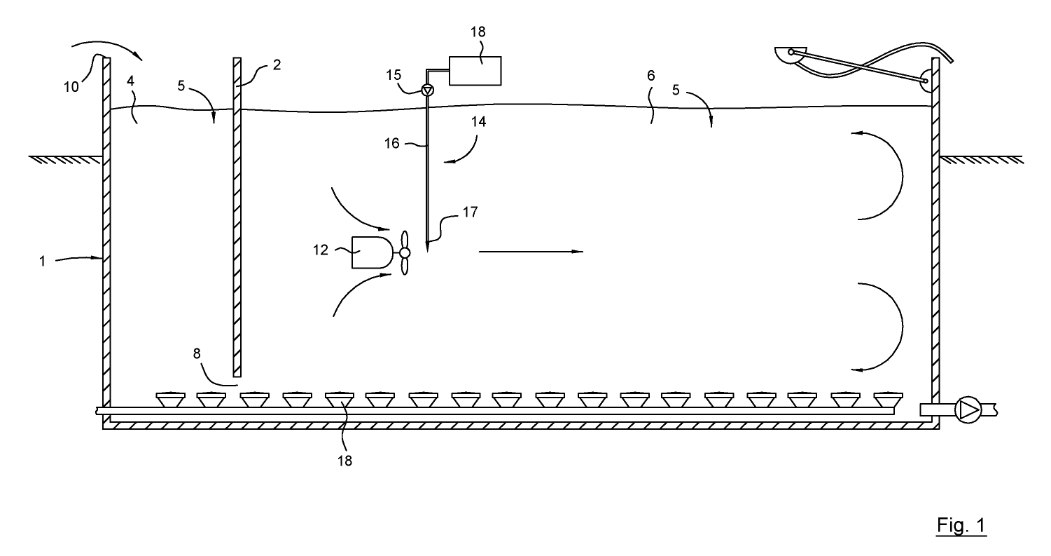

With reference to FIG. 1, a multi-purpose basin 1 suitable for SBR-process with continuous inflow of influent is shown. Basin 1 may be viewed as a bioreactor, i.e. a vessel that promotes biological reactions. To this purpose, the basin contains activated sludge (more thoroughly discussed further below).

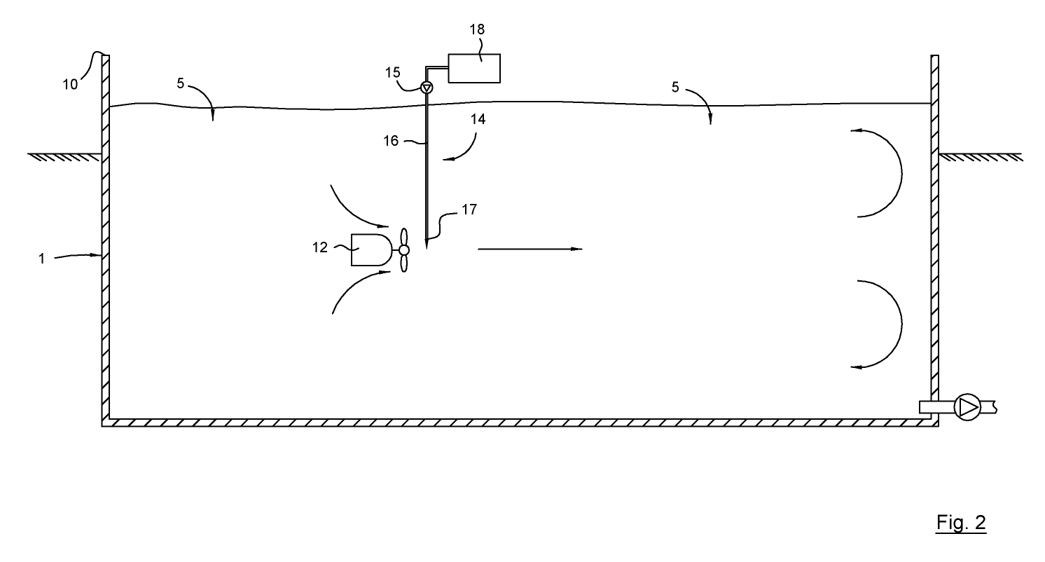

For the purposes of this application, the term influent is to be construed as encompassing any kind of wastewater upstream of the basin 1. Hence, both wastewater entering the treatment plant as well as wastewater flowing into the basin 1 are comprised. As will become evident, the method isn't limited to be used in an SBR-process nor is the use of a single basin necessary for achieving above-discussed positive effects. Here, a chemical treatment phase is in progress and the coagulant is being injected into the basin 1. As it may be seen in this non-limiting embodiment, a partition wall 2 separates a first section 4 (pre-reaction zone) of the basin in which the influent wastewater is received and a second section 6 (main-reaction zone) in which the reaction phase takes place. The partition wall 2 is in its lowermost portion provided with apertures 8 enabling flow of liquid between the sections 4, 6. More particularly, it renders possible continuous flow from the first section 4 towards the second section 6. Obviously, a single section basin 1 (shown in FIG. 2), lacking a partition wall and being suitable for a conventional SBR-process, is equally conceivable.

The basin 1 is arranged to receive influent municipal wastewater 5 that is introduced into the basin 1 by bringing it to brim over the edge 10 on the left-hand side of FIG. 1. To ensure optimal distribution of the binding compound, it is preferably injected at a location that is in proximity to a mixing unit 12 such as the shown, submerged mechanical mixer. More precisely, the binding compound is preferably injected at the pressure side of the mechanical mixer 12. The binding compound comprises a coagulant that is typically dissolved in a liquid such as water. Although a single mixer is disclosed, it is equally conceivable to employ a plurality of mixers.

An injection arrangement 14 comprises a pump 15 transferring, via a pipe 16 and a nozzle 17, the binding compound from a reservoir 18, positioned outside the basin, to the basin 1. In a related context, a plurality of aerator arrangements 18 is arranged in proximity to the bottom of the basin 1. These release small air bubbles that oxygenate the influent but may also participate in its mixing thus complementing or completely replacing the mechanical mixer 12. In conjunction herewith, the mixing in substep b) could be executed solely by means of the aerator arrangement 18 and/or the mechanical mixer 12. In a preferred embodiment shown in FIG. 1, the binding compound is added to the wastewater in the second section 6 of the basin of the SBR.

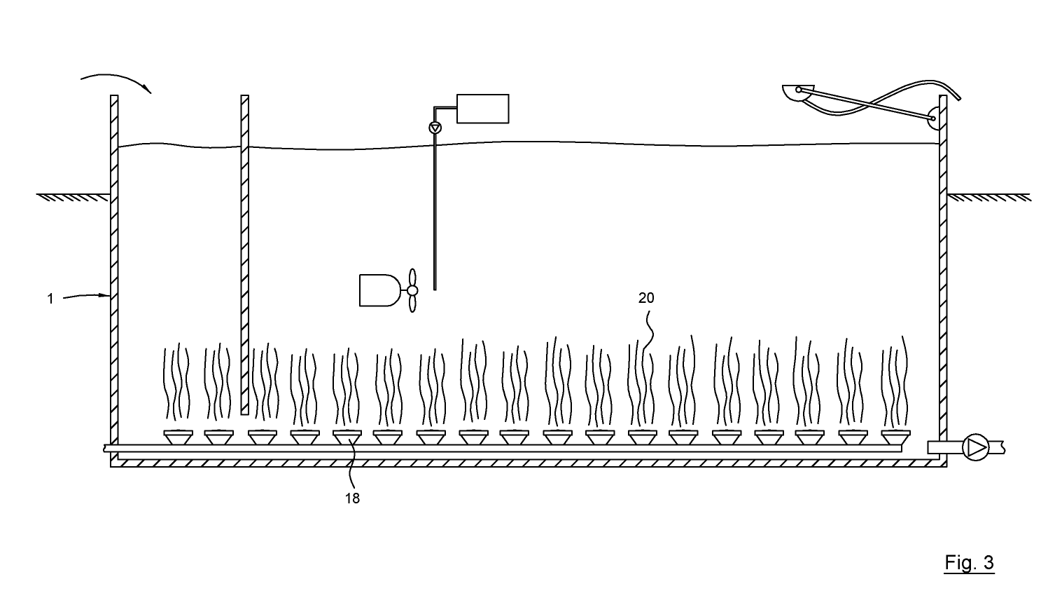

Further components of the basin will be discussed in conjunction with FIGS. 2 and 3. Here, components already disclosed in connection with FIG. 1, are not discussed anew. Moreover, throughout the drawings, like reference signs refer to like elements.

Above described multi-purpose basin 1 is suitable for carrying out a SBR-process having a reaction phase comprising a biological treatment phase and a subsequent chemical treatment phase. As an alternative, water treatment of this type may be carried out in a plurality of basins. More specifically, the biological treatment phase may be carried out in a first basin and the subsequent chemical treatment phase could be carried out in a second basin. Furthermore, the basin 1 may be used in a CAS-process, but also as a ditch in a widely used oxidation ditch process where wastewater circulates in the basin 1 and substances are kept suspended in the wastewater by means of aeration devices, or the basin may be constituted by a cylinder shaped basin comprising a top entry mixer

In this context, the biological treatment phase comprises alternating processes of oxygenation of the influent wastewater by means of the aerator arrangements 18, i.e. an aerobic process, and mixing by means of a mixing unit 12 without oxygen supply in an anoxic process. These processes are carried out in order to remove different materials from the wastewater. In this context, the wastewater, in addition to phosphorus, contains significant amounts of carbon and nitrogen. Accordingly, the above-mentioned, useful bacteria feed on the carbon present in the influent wastewater during the aerobic process. They also use small amounts of phosphorus as building material to create cells. The duration of the biological treatment phase is about 120 minutes. An inherent property of the SBR-process with continuous inflow of influent is that the influent wastewater 5 may enter the multi-purpose basin 1 at any time during the biological treatment phase.

Furthermore, the chemical treatment phase comprises a substep of mixing the wastewater 5 while injecting, in a manner described above, a predetermined dose of the binding compound into the basin 1, the binding compound being injected at a location in which the speed of the wastewater is equal to or more than 0.5 m/s in order for the binding compound to contact and coagulate the phosphorus-containing substances. This means that the binding compound needs to be injected at a more elevated speed. In general, the higher the speed of wastewater is, the less time is required to inject suitable amount of the binding compound. Consequently, high speed of wastewater in substep a) shortens the duration of the substep rendering the entire process more commercially viable. Considering the speed employed, said compound contacts without delay the wastewater 5 to a maximum possible extent. Sufficient and substantially uniform distribution of the binding compound with the coagulant throughout the wastewater 5 is hereby ensured. In preferred embodiments, the speed of the wastewater in substep a) is equal to or more than 4 m/s, more preferably equal to or more than 8 m/s, and more preferably equal to or more than 10 m/s. At any rate, the preferred speed of the wastewater 5 shouldn't exceed 20 m/s due to risk for cavitation in the basin 1. In a further preferred embodiment the speed of the wastewater ranges between 14 and 16 m/s. In another preferred embodiment, the duration of the mixing in the substep is equal to or more than 10 minutes and equal to or less than 30 minutes. Moreover, a sludge layer containing useful bacteria employed in the wastewater treatment has been dispersed throughout the liquid as a consequence of the mixing action.

The chemical treatment phase further comprises a substep of mixing the wastewater 5 such that an average speed of the wastewater 5 in the basin 1 is equal to or more than 0.1 m/s and equal to or less than 0.4 m/s, in order to flocculate the coagulated phosphorus-containing substance. The flocculation process will also be discussed in connection with FIG. 3. In a related embodiment, average speed of the wastewater 5 in the basin 1 is preferably equal to or more than 0.2 m/s and equal to or less than 0.4 m/s and most preferred average speed is 0.3 m/s. Accordingly, the mixing is rather gentle. This keeps the particles suspended and promotes flocculation without the risk of disunifying the growing flocs. In one embodiment, this gentle mixing is achieved by the mixing unit 12 and/or the aerator arrangement 18 alternating between on-state and off-state. In a preferred embodiment, the duration of the mixing in substep b) is equal to or more than 10 minutes and equal to or less than 30 minutes. Short mixing times in the substeps (well below 60 minutes) open for use of the method in full scale water treatment plants.

In a related context, the inventive method opens for significant reductions as regards sludge volume index (SVI). Consequently, smaller volumes of sludge are produced in the process. This, in turn, opens for reduction in size of the basin (bioreactor) used. Consequently, the investment cost associated with construction or retrofit of the basin (bioreactor) may be reduced accordingly. This beneficial aspect of the invention is more thoroughly discussed in connection with Example 4 below.

With reference to the above-mentioned biological, respectively chemical treatment phase, it is to be understood that the processes of consumption of carbon and nitrogen by the bacteria are not interrupted as long as the wastewater is present in the basin 1 whereas the consumption of phosphorus by the bacteria is only discontinued during substep a). More specifically, the phosphorus-containing substance coagulates at such a rate during substep a) that the consumption of phosphorus attributable to bacteria is negligible. However, the bacteria consume phosphorus during substep b), in particular if fresh influent is added.

In the above context, “mixing turnover” is a well-known term in the art. It may be defined as the time necessary for all liquid in the basin 1 to pass the mixing unit 12. It is a common way to describe a given basin-mixing unit combination. Its duration is typically between 150 and 250 seconds. In one embodiment, the injection of the dose of the binding compound into the basin 1 is performed during a time period equal to or more than a time period required to accomplish two mixing turnovers of the wastewater and equal to or less than a time period required to accomplish seven mixing turnovers of the wastewater, and preferably equal to a time period required to accomplish about five mixing turnovers of the wastewater. In a further embodiment, a time period required to accomplish a mixing turnover is determined only with respect to the content of the second section 6 of the basin 1.

A thereto related term is “basin turnover” that denotes a time period required to completely replace the liquid present in the basin at a given point in time. Its approximate value is 24 hours.

In yet another preferred embodiment, phosphorus concentration of the liquid in the chemical treatment phase (C_{P, chemical}) is determined by subtracting target phosphorus concentration in the effluent (C_{P,target,effluent}) and phosphorus concentration in the biological treatment phase (C_{P, biological}) from phosphorus concentration in the influent (C_{P, influent}) in which (C_{P,target,effluent}) is the target level of the phosphorus concentration of the effluent wastewater and (C_{P, biological}) is a concentration reflecting phosphorus uptake during the biological treatment phase. The target level may be inferred using historical data or it may be imposed by the legislator. Regardless, once said level has been set, it is possible to arrive at a theoretical value for an accurate phosphorus concentration of the liquid in the chemical treatment phase (C_{P, chemical}). The dosing regime is then adjusted accordingly.

Exemplifying the above, by virtue of the inventive method a realistic minimum target value for phosphorus concentration in the effluent (C_{P,target,effluent}) may be as low as 0.2-0.3 mg/L. It is in conjunction herewith to be noted that the EU-legislation lays down the value of 1.0 mg/L for maximum acceptable phosphorus concentration in the effluent. Typical values for phosphorus concentration in the biological treatment phase (C_{P, biological}) is about 3-4 mg/L and phosphorus concentration in the influent (C_{P, influent}) is of the order of 6-9 mg/L, respectively. Using these values, the (C_{P, chemical}) may then be determined and is of the order of 2-4 mg/L. Above may also be used if the overall purpose of the wastewater treatment is to reduce, in a controlled manner, the volume of sludge needed to be disposed while maintaining an acceptable value for phosphorus concentration in the effluent.

An alternative basin 1 is shown in FIG. 2. A schematic cross sectional side view of a structurally simple basin may be viewed. A chemical treatment phase is in progress and the coagulant is being injected into the basin 1. The shown basin 1 lacks the partition wall and the aerator arrangement. Nevertheless, the basin 1 is suitable for executing the inventive method. In this context, as regards the operation of the basin 1, the reference is made to the corresponding description of operation in connection with FIG. 1.

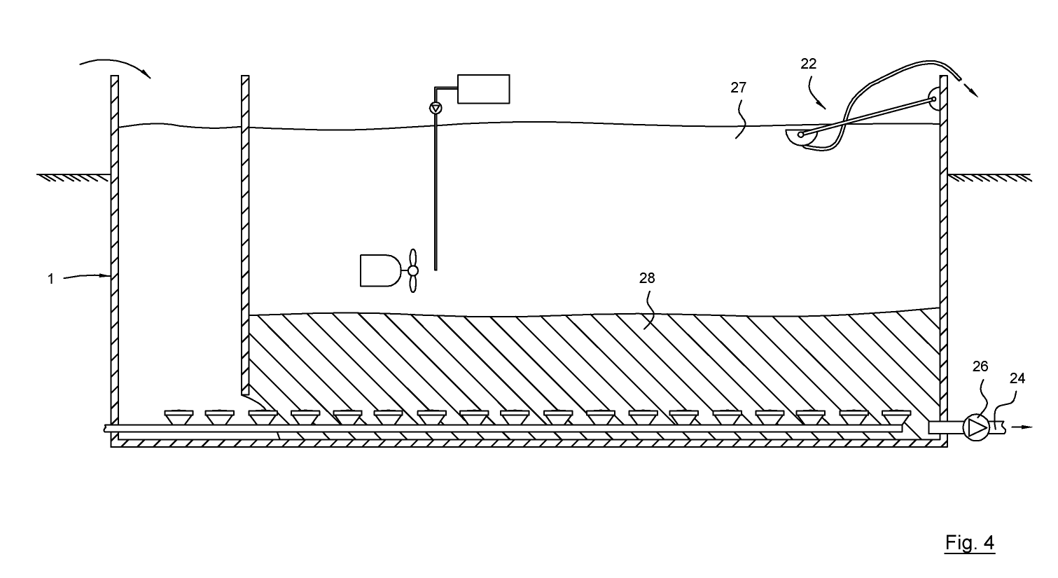

Turning to FIG. 3, a schematic cross sectional side view of a multi-purpose basin 1 suitable for a SBR-process with continuous inflow of influent, during a chemical treatment phase, is shown. The FIG. 3 shows the completion of flocculation process and oxygenation of the wastewater by means of small air bubbles 20. As a consequence, the flocculated phosphorus-containing substances settle in the basin 1 such that clear wastewater is eventually obtained at the top of the basin 1 and an activated sludge layer is formed at the bottom of the basin. Here, the binding compound isn't injected into the basin and there is no mixing. The growing flocs sink towards the bottom of the basin and build on the activated sludge layer. Said layer will be discussed in more detail in connection with FIG. 4. The duration of the settling phase is in one embodiment equal to or more than 30 minutes and equal to or less than 90 minutes. In a further embodiment, the duration of the settling phase is equal to or more than 45 minutes and equal to or less than 75 minutes and 60 minutes in the most preferred embodiment. Further components of the basin will be discussed in conjunction with FIG. 4.

With reference to FIG. 4, a schematic cross sectional side view of a multi-purpose basin 1 suitable for a SBR-process with continuous inflow of influent, during a chemical treatment phase, is shown. Here, the flocculated matter has settled and decantation/extraction is in progress. The inventive method further comprises the step of executing an extraction phase, in which the clear wastewater 27 is decanted from the basin 1 as effluent wastewater. To this purpose an arrangement 22 for evacuating the effluent wastewater is arranged near top of the basin 1. Moreover, an outlet conduit 24 for sludge 28 evacuation is located near bottom of the basin. Thereto associated pump 26 removes, when in operation, a portion of the activated sludge layer 28 from the basin so that the sludge layer is only gradually replaced. As certain coagulants preserve a certain level of reactivity also when bound to the phosphorus-containing substance and settled in the activated sludge layer 28, the removal of phosphorus may hereby be continued and efficiency of the process may be improved. The duration of the extraction phase is in one embodiment equal to or more than 30 minutes and equal to or less than 90 minutes. In a further embodiment, the duration of the settling phase is equal to or more than 45 minutes and equal to or less than 75 minutes, and 60 minutes in the most preferred embodiment.

The coagulant used for water treatment could be a salt, e.g. a chloride or a sulphate. Moreover, the coagulant may comprise a rare earth ion such as cerium, but it may also comprise a metal ion such as iron. In one embodiment, the coagulant may be cerium trichloride (CeCl₃). Use of cerium trichloride may reduce the amount of the injected coagulant by up to 30%. Effects of this and other coagulants on the coagulation process are thoroughly discussed in the examples below.

The following examples are provided to illustrate certain embodiments and are not to be construed as limitations on the embodiments. In the examples, BOD-level is determined by subtracting BOD-level of the effluent wastewater from the BOD-level of the influent wastewater. BOD-level is variable since it is temperature- and site-dependent. Moreover, BOD-level may be a predetermined value, e.g. calculated on weekly basis, or a measured, instantaneous value.

### Example 1

### Introduction

Experiments were performed in order to study effects of the proposed method on the efficiency of removal of phosphorus species from waste water in general, and particulate phosphorus as well as dissolved orthophosphate in particular. To this purpose, either iron trichloride (FeCl₃) or cerium trichloride (CeCl₃) were used as coagulants in a jar test comprising the injection, mixing, and separation method steps as specified in the embodiments of the present invention.

The parameters for the experiments were as follows:

The reaction media is mixed liquor sampled directly from the main reaction basin from an SBR and containing activated sludge.

Municipal wastewater is used as influent.

Stock solutions for the phosphorus-binding compound were either FeCl₃ (0.058 M or 11 g/L) or CeCl₃ (1.97 M or 485 g/L).

The concentrations of the various species of phosphorus available to the chemical reaction were directly measured in the clear wastewater effluent.

Content of the respective mixed liquor sample is presented in Table 1. More particularly, concentrations of phosphorus-containing compounds in the collected samples are shown. It is here to be noted that, for some of the collected samples, the concentration of available total phosphorus in the basin was for the purposes of the test intentionally increased by maintaining the activated sludge under anaerobic conditions for several hours before sampling.

TABLE 1

| | Total | Particulate | Dissolved |
|---|---|---|---|
| | phosphorus | Phosphorus | Orthophosphate |
| | [P] | [P] | [P] |
| | (mg/L) | (mg/L) | (mg/L) |
| Mixed Liquor Sample 1 | 18.8 | 1.0 | 17.7 |
| Mixed Liquor Sample 2 | 3.80 | 0.44 | 3.31 |
| Mixed Liquor Sample 3 | 13.0 | 0.50 | 12.3 |
| Mixed Liquor Sample 4 | 13.5 | 0.80 | 12.5 |

Further relevant parameters are presented below:
Total suspended solid concentration in activated sludge: about 1800 mg/L
Reaction volume: 1000 mL
Substep a: fast mixing conditions
Coagulation time: 60 s (more than twice the turnover time)
Coagulation mixing speed: 0.5 m/s
Substep b: slow mixing condition
Flocculation time: 15 min
Flocculation mixing speed: 0.1 m/s
Analytical Instrument: WTW Spectrophotometer 6600 UV-VIS
Separation: settling for 30 min
Filtration: Syringe filter (surfactant-free cellulose acetate membrane) with nominal pore size of 0.45 μm

Description of the Experiments

The performance of the phosphorus-binding compounds to remove the phosphorus species from the mixed liquor samples were assessed by adding chemicals comprising metallic/rare earth ion (Fe/Ce) so that a range of molar ratios between the metallic/rare earth ion (Fe/Ce) and the total phosphorus (P) is created. For each collected sample, six one liter jars were filled and used to test various molar ratios. Tested molar ratios for each of the collected samples are shown in Table 2.

TABLE 2

| | Mixed Liquor | Mixed Liquor | Mixed Liquor | | Mixed Liquor |
|---|---|---|---|---|---|
| | Sample 1 | Sample 2 | Sample 3 | | Sample 4 |
| | CeCl₃ | CeCl₃ | CeCl₃ | FeCl₃ | FeCl₃ |
| | Molar Me:P | Molar Me:P | Molar Me:P | Molar Me:P | Molar Me:P |
| Jar number 1 | 0 | 0.34 | 0.54 | | 1.1 |
| Jar number 2 | 0.26 | 0.66 | 1.1 | | 2.2 |
| Jar number 3 | 0.60 | 0.99 | 2.2 | | 2.8 |
| Jar number 4 | 0.86 | 1.32 | | 4.0 | 3.4 |
| Jar number 5 | 2.58 | 1.65 | | 6.0 | 3.9 |
| Jar number 6 | 6.03 | 1.97 | | 8.0 | 4.5 |

Following the addition of either chemical, the respective sample was successively mixed at the suggested speeds for optimal coagulation and flocculation. Residual phosphorus species were measured in the clear wastewater effluent obtained after a settling of the sludge.

Phosphorus and orthophosphate contents were then measured using a WTW spectrophotometer. The detection of phosphorus to detection limit of 0.05 mg/L was done using the standard method EV 08 SS-EN ISO 6878:2005. Dissolved fractions of phosphorus were filtered immediately after collection of the samples. The concentration in particulate phosphorus is the difference between total phosphorus and dissolved total phosphorus.

Results

Obtained results are visualized in Tables 3-5, where:

Table 3 shows variation in the concentration of total phosphorus in effluent with the tested molar ratio,

Table 4 shows variation in the concentration of total phosphorus in effluent particulate with the tested molar ratio, and

Table 5 shows variation in the concentration of dissolved orthophosphate in effluent with the tested molar ratio.

TABLE 3

| | Total phosphorus [P] | | | | Total phosphorus [P] | |
|---|---|---|---|---|---|---|
| | (mg/L) | | | | (mg/L) | |
| | Mixed | Mixed | Mixed | | Mixed | Mixed |
| CeCl₃ | liquor | liquor | liquor | FeCl₃ | liquor | liquor |
| Me:P | Sample 1 | Sample 2 | Sample 3 | Me:P | Sample 3 | Sample 4 |
| 0.26 | 12.3 | | | 1.1 | | 3.8 |
| 0.34 | | 2.98 | | 2.2 | | 0.40 |
| 0.54 | | | 4.80 | 2.8 | | 0.30 |
| 0.60 | 5.20 | | | 3.4 | | |
| 0.66 | | 1.59 | | 3.9 | | |
| 0.86 | 1.43 | | | 4.0 | 0.30 | |
| 0.99 | | 0.75 | | 4.5 | | |
| 1.10 | | | 0.40 | 6.0 | 2.7 | |
| 1.32 | | 0.38 | | 8.0 | 4.12 | |
| 1.65 | | 0.51 | | | | |
| 1.97 | | 0.19 | | | | |
| 2.20 | | | 0.12 | | | |
| 2.60 | 0.13 | | | | | |
| 6.00 | 0.18 | | | | | |

TABLE 4

| | Particulate Total phosphorus [P] | | | | Particulate Total phosphorus [P] | |
|---|---|---|---|---|---|---|
| | (mg/L) | | | | (mg/L) | |
| | Mixed | Mixed | Mixed | | Mixed | Mixed |
| CeCl₃ | liquor | liquor | liquor | FeCl₃ | liquor | liquor |
| Me:P | Sample 1 | Sample 2 | Sample 3 | Me:P | Sample 3 | Sample 4 |
| 0.26 | 0.7 | | | 1.1 | | 0.8 |
| 0.34 | | 0.36 | | 2.2 | | 0.20 |
| 0.54 | | | 0.10 | 2.8 | | |
| 0.60 | 0.40 | | | 3.4 | | |
| 0.66 | | 0.19 | | 3.9 | | |
| 0.86 | 0.18 | | | 4.0 | 0.26 | |
| 0.99 | | 0.14 | | 4.5 | | |
| 1.10 | | | 0.10 | 6.0 | 2.4 | |
| 1.32 | | 0.11 | | 8.0 | 2.82 | |
| 1.65 | | 0.13 | | | | |
| 1.97 | | 0.11 | | | | |
| 2.20 | | | 0.08 | | | |
| 2.60 | 0.10 | | | | | |
| 6.00 | 0.14 | | | | | |

TABLE 5

| | Dissolved Orthophosphate [P] | | | | Dissolved Orthophosphate [P] | |
|---|---|---|---|---|---|---|
| | (mg/L) | | | | (mg/L) | |
| | Mixed | Mixed | Mixed | | Mixed | Mixed |
| CeCl₃ | liquor | liquor | liquor | FeCl₃ | liquor | liquor |
| Me:P | Sample 1 | Sample 2 | Sample 3 | Me:P | Sample 3 | Sample 4 |
| 0.26 | 11.6 | | | 1.1 | | 0.05 |
| 0.34 | | 2.6 | | 2.2 | | 0.03 |
| 0.54 | | | 4.50 | 2.8 | | |
| 0.60 | 4.90 | | | 3.4 | | |
| 0.66 | | 1.37 | | 3.9 | | |
| 0.86 | 1.23 | | | 4.0 | 0.03 | |
| 0.99 | | 0.59 | | 4.5 | | |
| 1.10 | | | 0.16 | 6.0 | 0.1 | |
| 1.32 | | 0.25 | | 8.0 | 0.98 | |
| 1.65 | | 0.35 | | | | |
| 1.97 | | 0.05 | | | | |
| 2.20 | | | 0.03 | | | |
| 2.60 | 0.05 | | | | | |
| 6.00 | 0.03 | | | | | |

### Conclusions

The results presented in Tables 3-5 demonstrate that, using activated sludge from an SBR-process, the optimal metal/rare earth-phosphorus molar ratios for CeCl₃ and FeCl₃, i.e. those minimizing concentration of phosphorus, are 2.2 and 2.8, respectively. Under these well controlled conditions, the lowest concentration of total phosphorus was 0.12 mg/L for CeCl₃ and 0.30 mg/L for FeCl₃, and the lowest concentration of dissolved orthophosphate was 0.03 mg/L for both phosphate-binding compounds.

### Example 2

### Introduction

Large-scale experiments were performed in order to study effects of the proposed method on the efficiency of removal of phosphorus species from waste water in general, and particulate phosphorus as well as dissolved orthophosphate in particular. In these experiments either iron trichloride (FeCl₃) or cerium trichloride (CeCl₃) were used as coagulants in a pilot scale sequential batch reactor (SBR) with continuous inflow. The injection, mixing, and separation method steps were executed as specified in the embodiments of the present invention.

The general parameters for the experiments were as follows:

Municipal wastewater is used as inflow to the SBR.

The reaction media is the mixed liquor of the SBR containing activated sludge.

Stock solutions for the phosphorus-binding compound were either FeCl₃ (2.89 M or 469 g/L) or CeCl₃ (1.97 M or 485 g/L).

The concentrations in total phosphorus in the mixed liquor available to the chemical reaction is calculated from the total phosphorus measured in the inflow of the SBR, the targeted concentration in total phosphorus in the effluent of the SBR, and the concentration in total phosphorus uptaken by the biology. The concentration in total phosphorus uptaken by the biology is calculated from the biological oxygen demand in the influent of the SBR, the biological oxygen demand in the effluent of the SBR, the sludge yield, and the mass fraction of total phosphorus in the dry sludge. The estimation of the total phosphorus available to chemical reaction does not give the concentrations in particulate total phosphorus and dissolved orthophosphate.

In all experiments, the injection, mixing, and separation method steps used were as follows:
Duration of the injection step (substep a): 15 to 24 min according to the dose of chemical—corresponding to minimum of two turnover time.
Location of the injection: pressurized side of the mechanical mixer.
Mixing speed at the injection point: 14 m/sec
Duration of mixing for the purpose of flocculation (substep b): 24 min
Average mixing speed for the purpose of flocculation: 0.3 m/s
Separation: settling of the sludge
Separation duration: 60 min
Filtration: Syringe filter (surfactant-free cellulose acetate membrane) with nominal pore size: 0.45 μm

The parameters for the experiment using CeCl₃ as phosphorus-binding compound are as follows:
Duration of the test: 10 days
Average concentration in total phosphorus in the influent: 5.0 mg/L
Targeted concentration in total phosphorus in the effluent: 0.2 mg/L
Average BOD-level in the influent: 300 mg/L
Average BOD-level in the effluent: 6 mg/L
Average concentration of phosphorus taken up by the biology: 5.0 mg/L
Average phosphorus concentration available for the chemical reaction: 2.0 mg/L
Mixed liquor suspended solid: approximately 2000 mg/L

The parameters for the experiment using FeCl₃ as phosphorus-binding compound are as follows:
Duration of the test: 15 days
Average phosphorus concentration in the influent: 6.63 mg/L
Targeted phosphorus concentration in the effluent: 0.2 mg/L
Average BOD-level in the influent: 360 mg/L
Average BOD-level in the effluent: 5 mg/L
Average concentration of phosphorus taken up by the biology: 3.3 mg/L
Average phosphorus concentration available for the chemical reaction: 3.3 mg/L
Mixed liquor suspended solid: approximately 2000 mg/L

The performances of the phosphorus-binding chemicals to remove the phosphorus species from the mixed liquor were assessed by adding the chemical over a range of molar ratios between the metal-ion and the total phosphorus available to the chemical reaction. Residual phosphorus species were measured in the clear phase of the sample after a settling of the sludge.

In these experiments, the measurements of phosphorus and biological demand were done on composite sample collected over a 24-hour period. Carbonaceous BOD was measured by pressure measurement in a closed system over five days using OxiTop (WTW). Phosphorus and orthophosphate were measured with respect to phosphorus using a WTW spectrophotometer 6600 UV-VIS. The detection of phosphorus to detection limit of 0.05 mg/L was done using the standard method EV 08 SS-EN ISO 6878:2005. Dissolved fractions of phosphorus were filtered immediately after collection of the samples. The concentration in particulate phosphorus is the difference between total phosphorus and dissolved total phosphorus.

Results

Obtained results are visualized in Tables 6 and 7.

More particularly, for the experiment using CeCl₃ in the SBR, variation of the Ce:P molar ratio is shown in Table 6. The injection of CeCl₃ started on day 0 and was adjusted daily according to the changes in available total phosphorus in the mixed liquor. The metal:phosphorus molar ratio is calculated using the available total phosphorus in the mixed liquor.

TABLE 6

| | Total Phosphorus | | | | CeCl₃ | |
|---|---|---|---|---|---|---|
| | | | Available | | | Me:P |
| | | | to | | Me:P | based on |
| | | in | chemical | | based on | total |
| | Influent | influent | reaction | | available | phosphorus |
| | Flow | waste | in mixed | | phosphorus | in the |
| | rate | water | liquor | | in the mixed | influent |
| | (m3/day) | [P] (mg/L) | [P] (mg/L) | (g/day) | liquor | wastewater |
| day −2 | 24 | 8.3 | | 0 | 0 | 0 |
| day −1 | 24 | 6.4 | | 0 | 0 | 0 |
| day 0 | 24 | 5.8 | 2.8 | 696 | 1.3 | 0.63 |
| day 1 | 24 | 6 | 3 | 631 | 1.1 | 0.55 |
| day 2 | 24 | 7.3 | 4.3 | 650 | 0.8 | 0.47 |
| day 3 | 22 | 7.3 | 4.3 | 650 | 0.9 | 0.51 |
| day 4 | 26 | 4.1 | 1.1 | 595 | 2.6 | 0.70 |
| day 5 | 28 | 4.5 | 1.5 | 481 | 1.4 | 0.48 |
| day 6 | 27 | 4.5 | 1.5 | 572 | 1.8 | 0.60 |
| day 7 | 26 | 4.4 | 1.4 | 809 | 2.8 | 0.89 |
| day 8 | 28 | 4.5 | 1.5 | 777 | 2.3 | 0.77 |
| day 9 | 27 | 3.9 | 0.9 | 575 | 3.0 | 0.69 |
| day 10 | 30 | 4.4 | 1.4 | 475 | 1.4 | 0.45 |

Moreover, for the experiment using FeCl₃ in the SBR, the variation of the Fe:P molar ratio is shown in Table 7. The injection of FeCl₃ started on day 0 and was adjusted daily according to the changes in available total phosphorus in the mixed liquor. The metal:phosphorus molar ratio is calculated using the available total phosphorus in the mixed liquor.

TABLE 7

| | | | FeCl₃ | |
|---|---|---|---|---|
| | Total | Total Phosphorus | Me:P based | Me:P |
| | phosphorus | available to | on available | based on total |
| | in influent | chemical reaction | phosphorus | phosphorus |
| | waste water | in mixed liquor | in the mixed | in the influent |
| | [P] (mg/L) | [P] (mg/L) | liquor | wastewater |
| day 0 | 6 | 2.7 | 0.7 | 0.32 |
| day 1 | 6.4 | 3.1 | 0.7 | 0.32 |
| day 2 | 6.7 | 3.4 | 0.7 | 0.32 |
| day 3 | 6.0 | 2.7 | 0.7 | 0.32 |
| day 4 | 6.2 | 2.9 | 1.4 | 0.65 |
| day 5 | 6.2 | 2.9 | 1.4 | 0.65 |
| day 6 | 7.3 | 4 | 1.4 | 0.65 |
| day 7 | 8.9 | 5.6 | 1.4 | 0.65 |
| day 8 | 6.7 | 3.4 | 1.4 | 0.65 |
| day 9 | 5.3 | 2 | 1.4 | 0.65 |
| day 10 | 6.5 | 3.2 | 1.4 | 0.65 |
| day 11 | 7.4 | 4.1 | 1.5 | 0.72 |
| day 12 | 6.3 | 3 | 1.5 | 0.72 |
| day 13 | 7.1 | 3.8 | 1.5 | 0.72 |
| day 14 | 6.5 | 3.2 | 1.5 | 0.72 |

Conclusions

The results of the experiment with CeCl₃ presented in Table 8 below show variation in concentration of total phosphorus and dissolved orthophosphate in the effluent after injection of cerium chloride. Hence, a sustained injection of the binding compound at an average metal:phosphorus molar ratio of 1.8 according to the inventive method for injection and mixing the chemical in the basin reliably reduces the total phosphorus and dissolved orthophosphate in the SBR-effluent to concentrations lower than 0.26 and 0.07 mg/L, respectively. The given average molar ratio of 1.8 was obtained using the concentration of phosphorus available to the chemical reaction in the mixed liquor. This molar ratio is equivalent to a molar ratio of 0.6 if the total phosphorus in the influent wastewater is used.

TABLE 8

| | CeCl₃ | | | |
|---|---|---|---|---|
| | Me:P | | | |
| | based on | | | |
| | available | Total | Particulate | Dissolved |
| | phosphorus | phosphorus | Phosphorus | orthophosphate |
| | in the | [P] | [P] | [P] |
| | mixed liquor | (mg/L) | (mg/L) | (mg/L) |
| day −2 | 0 | 0.92 | | 0.78 |
| day −1 | 0 | 0.98 | 0.19 | 0.72 |
| day 0 | 1.3 | 2.9 | 0.4 | 2.50 |
| day 1 | 1.1 | 0.44 | 0.14 | 0.25 |
| day 2 | 0.8 | 0.22 | 0.12 | 0.06 |
| day 3 | 0.9 | 0.31 | 0.12 | 0.15 |
| day 4 | 2.6 | 0.23 | 0.12 | 0.08 |
| day 5 | 1.4 | 0.23 | 0.13 | 0.06 |
| day 6 | 1.8 | 0.31 | 0.2 | 0.07 |
| day 7 | 2.8 | 0.22 | 0.12 | 0.07 |
| day 8 | 2.3 | 0.24 | 0.15 | 0.05 |
| day 9 | 3.0 | 0.26 | 0.16 | 0.06 |
| day 10 | 1.4 | 0.24 | 0.15 | 0.05 |

The results of the experiment with FeCl₃ presented in Table 9 below show variation in concentration of total phosphorus and dissolved orthophosphate in the effluent after injection of iron chloride. Hence, a sustained injection of the binding compound at an average metal:phosphorus molar ratio of 1.5 following the injection and mixing protocol described in the invention reliably reduces the total phosphorus and dissolved orthophosphate in the SBR effluent to concentrations lower than 1.2 and 1.0 mg/L, respectively. The given average molar ratio of 1.5 was obtained using the concentration of phosphorus available to the chemical reaction in the mixed liquor. This molar ratio is equivalent to a molar ratio of 0.72 if the total phosphorus in the influent wastewater is used.

TABLE 9

| | FeCl₃ | Total | Dissolved |
|---|---|---|---|
| | Me:P | phosphorus | orthophosphate |
| | based on available phosphorus | [P] | [P] |
| | in the mixed liquor | (mg/L) | (mg/L) |
| day 0 | 0.7 | 2.0 | 1.8 |
| day 1 | 0.7 | 2.1 | 2.0 |
| day 2 | 0.7 | 2.2 | 2.1 |
| day 3 | 0.7 | 2.0 | 1.9 |
| day 4 | 1.4 | 1.2 | 1.0 |
| day 5 | 1.4 | 1.3 | 1.11 |
| day 6 | 1.4 | 1.6 | 1.3 |
| day 7 | 1.4 | 1.4 | 1.2 |
| day 8 | 1.4 | 1.4 | 1.2 |
| day 9 | 1.4 | 1.4 | 1.3 |
| day 10 | 1.4 | 1.2 | 1.0 |
| day 11 | 1.5 | 1.0 | 1.0 |
| day 12 | 1.5 | 1.1 | 1.0 |
| day 13 | 1.5 | 1.2 | 1.0 |
| day 14 | 1.5 | 1.2 | 1.0 |

### Example 3

### Introduction

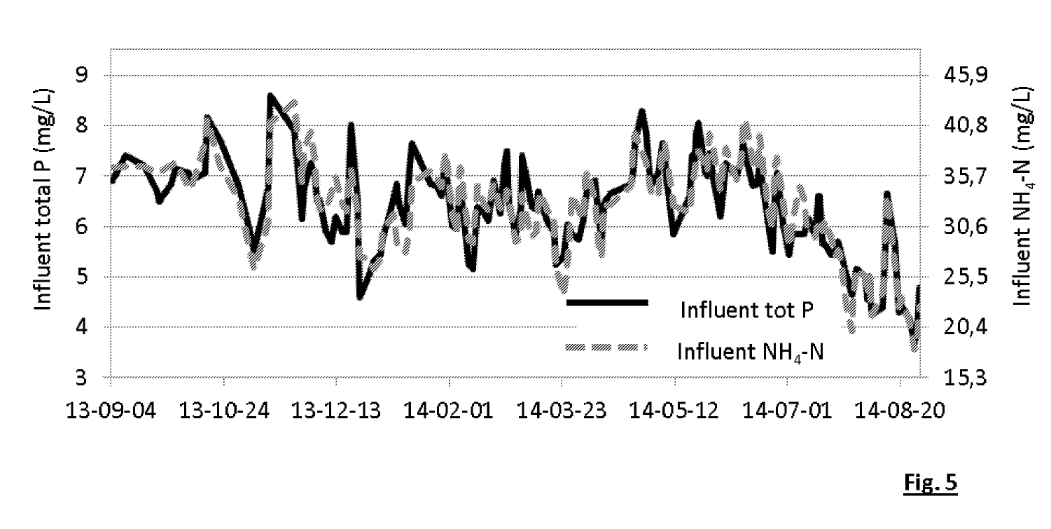

The correlation of concentrations of a nitrogen-containing compound (dashed line) and total phosphorus (continuous line) in municipal wastewater has been investigated in an experiment using municipal wastewater of Stockholm (Sweden), Cochranton (PA, USA) and El Monte (Chile), respectively, as direct influent to a basin (bioreactor) (FIGS. 5 to 7). In Stockholm and Cochranton the nitrogen-containing compound was ammonium nitrogen (NH₄—N) whereas the nitrogen-containing compound in El Monte was Total Kjeldahl nitrogen (TKN). As is known in the art, TKN is the sum of organic nitrogen, ammonia (NH₃), and ammonium (NH₄+) present in the tested sample. The level of respective nitrogen-containing compound in the wastewater was monitored for a period of twelve month.

The details of the monitoring were as follows:

Stockholm:

Continuous measurement of ammonia concentration, indirectly measured via NH₄—N, was done with an ISE probe containing NH₄—N and potassium (compensation ion) electrodes (Varion™ Plus 700 IQ, WTW). In this context, concentration of ammonia nitrogen in wastewater is representative for determining concentration of ammonia (NH₃).

Measurement of total phosphorus concentration was made in a laboratory approximately four times per week using the standard method EV 08 SS-EN ISO 6878:2005.

Sample used for phosphorus analysis was a composite sample collected over a 24-hour period.

Cochranton:

Biweekly measurement of ammonia concentration, indirectly measured via NH₄—N, was done through laboratory analysis using standard EPA Method 350.1.

Measurement of total phosphorus concentration was done through laboratory analysis using the standard method EV 08 SS-EN ISO 6878:2005.

Sample used for phosphorus analysis was a composite sample collected over a 24-hour period.

El Monte:

Biweekly measurement of TKN-concentration was done through laboratory analysis using standard EPA Method 350.2.

Measurement of total phosphorus concentration was done through laboratory analysis using the standard method EV 08 SS-EN ISO 6878:2005.

Sample used for phosphorus analysis was a composite sample collected over a 24-hour period.

Results

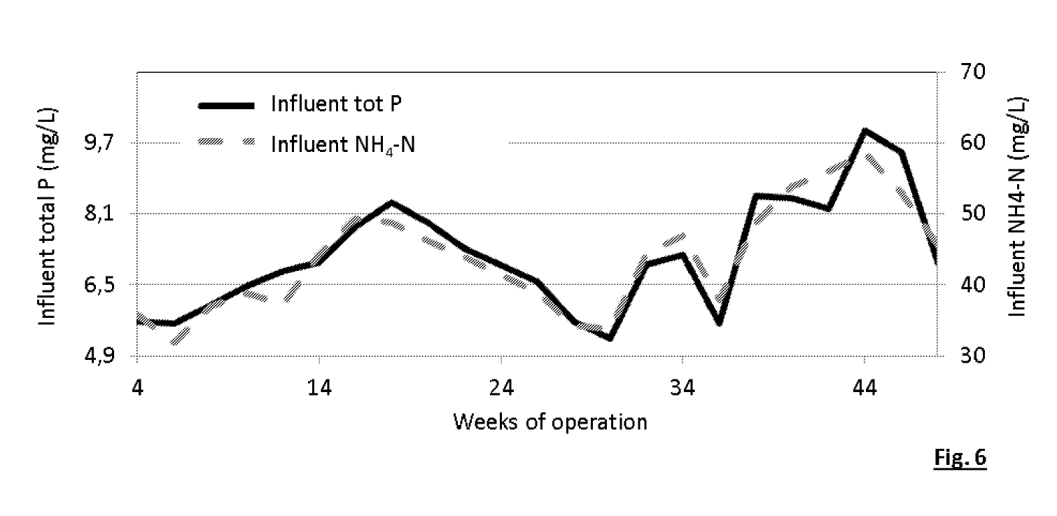

The results collected in Stockholm and Cochranton (visualised in FIGS. 5 and 6) demonstrate, independently of each other, that the concentrations of ammonia nitrogen (dashed line) and total phosphorus (continuous line) in municipal wastewater are closely correlated.

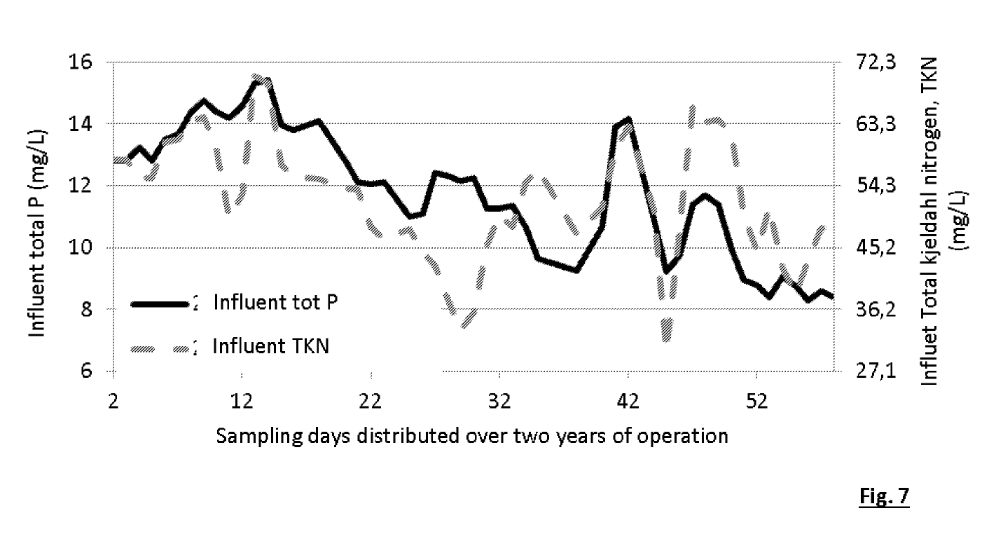

Results collected in El Monte (visualised in FIG. 7) demonstrate that a certain correlation exists between TKN (dashed line) and total phosphorus (continuous line) in municipal wastewater.

Conclusions

Hence, the measurement of ammonia nitrogen is a reliable procedure to estimate the total phosphorus concentration in municipal wastewater.

As listed in Table 10 below, the Stockholm-test established that the average, minimum and maximum mass ratios of ammonia-nitrogen and phosphorus in Stockholm municipal wastewater are 5.1; 3.7; and 6.5; respectively.

TABLE 10

| | Ammonia | Total phosphorus | Mass |
|---|---|---|---|
| | [N] | [P] | ratio |
| | (mg/L) | (mg/L) | NH4:P |
| Average | 32.5 | 6.4 | 5.1 |
| Standard | 5.8 | 1.1 | 0.5 |
| deviation | | | |
| Minimum | 16.1 | 3.0 | 3.7 |
| Maximum | 53.3 | 10.3 | 6.5 |

In this context and as listed in Table 11 below, the Cochranton-test established that the average, minimum and maximum mass ratios of ammonia-nitrogen and phosphorus in Cochranton municipal wastewater are 6.2; 5.3; and 7.0; respectively.

TABLE 11

| | Ammonia | Total phosphorus | Mass |
|---|---|---|---|
| | [N] | [P] | ratio |
| | (mg/L) | (mg/L) | NH4:P |
| Average | 43.9 | 7.1 | 6.2 |
| Standard | 9.1 | 1.6 | 0.6 |
| deviation | | | |
| Minimum | 31.0 | 5.2 | 5.3 |
| Maximum | 64.0 | 12.0 | 7.0 |

The tests performed in El Monte, listed in Table 12 below, establish that the average, minimum and maximum mass ratios of TKN and phosphorus in municipal wastewater are 4.5; 2.7; and 6.9.

TABLE 12

| | TKN | Total phosphorus | Mass |
|---|---|---|---|
| | [N] | [P] | ratio |
| | (mg/L) | (mg/L) | TKN:P |
| Average | 52.3 | 11.8 | 4.5 |
| Standard deviation | 11.2 | 2.2 | 1.0 |
| Minimum | 28.2 | 8.0 | 2.7 |
| Maximum | 76.6 | 16.2 | 6.9 |

### Example 4

### Introduction

Experiments were performed in order to study effects of the proposed method on the characteristics of the sludge after chemical reaction. Moreover, sludge volume index (SVI), describing the ability of the sludge to settle and compact, as well as the time required for 95% settling, i.e. time period required to achieve that 95% of the coagulated matter is settled, was determined for different wastewater samples. To this purpose, either iron trichloride (FeCl₃) or cerium trichloride (CeCl₃) were used as coagulants in a jar test comprising the injection, mixing, and separation method steps as specified in the embodiments of the present invention.

The parameters for the experiments were as follows:

The reaction media is mixed liquor sampled directly from a conventional activated sludge basin with no chemical addition.

Municipal wastewater is used as influent.

Stock solutions for the phosphorus-binding compound were either FeCl₃ (0.058 M or 11 g/L) or CeCl₃ (1.97 M or 485 g/L).

The concentration of phosphorus available to the chemical reaction directly measured in the clear wastewater effluent was 6.6 mg/L.

Further relevant parameters are presented and/or defined below:
Reaction volume: 1000 mL
Substep a: fast mixing conditions
Coagulation time: 60 s (more than twice the turnover time)
Coagulation mixing speed: 0.5 m/s
Substep b: slow mixing condition
Flocculation time: 15 min
Flocculation mixing speed: 0.1 m/s
Separation: settling for 30 min
Sludge volume at time (t): volume of the sludge blanket during settling at specific time (t), where 0≦t≦30 min Sludge volume index (SVI): ratio between the sludge volume at t=30 min and the mixed liquor concentration after chemical reaction
Time to 95% settling: Time required for the clear phase to reach 95% of its maximum height obtained after 30-min settling

Description of the Experiments

The performances of the phosphorus-binding compounds to affect the sludge characteristics were assessed by adding chemicals comprising metallic/rare earth ion (Fe/Ce) so that a range of molar ratios between the metallic/rare earth ion (Fe/Ce) and the total phosphorus (P) is created. The collected sample of active mixed liquor was apportioned into six one liter jars to test various molar ratios.

The molar metal:phosphorus ratio used for cerium trichloride were 2.0, 3.0, and 3.5, respectively.

The molar metal:phosphorus ratio used for iron trichloride were 3.5, 3.7, and 4.3, respectively.

Following the addition of either chemical, the respective sample was successively mixed at the suggested speeds for optimal coagulation and flocculation.

The concentration in total suspended solids was measured for each jar at the end of the flocculation period, before settling. Sludge volume was measured every five minutes until the end of settling. SVI and the time to 95% settling were calculated for each jar based on the obtained sludge volume functions and the respective concentrations in total suspended solids in the mixed liquor.

Results

Obtained results are visualized in Tables 13 and 14, where:

Table 13 shows variation in the total suspended solids, sludge volume and SVI with the tested molar ratio, and

Table 14 shows variation in the time to 95% settling with the tested molar ratio.

TABLE 13

| | | | CeCl₃ | | | FeCl₃ | | |
|---|---|---|---|---|---|---|---|---|
| | | No addition | Molar Me:P | | | Molar Me:P | | |
| | | of chemicals | 2 | 3 | 3.5 | 3.5 | 3.7 | 4.3 |
| Total suspended solids after | (mg/L) | 2248 | 2698 | 2810 | 2866 | 2675 | 2698 | 2743 |
| chemical reaction | | | | | | | | |
| Sludge volume after 0 min | (mL) | 1000 | 1000 | 1000 | 1000 | 1000 | 1000 | 1000 |
| Sludge volume after 5 min | (mL) | 760 | 430 | 420 | 440 | 670 | 630 | 590 |
| Sludge volume after 10 min | (mL) | 530 | 300 | 310 | 330 | 510 | 460 | 420 |
| Sludge volume after 15 min | (mL) | 440 | 290 | 290 | 290 | 410 | 390 | 350 |
| Sludge volume after 20 min | (mL) | 380 | 280 | 280 | 280 | 370 | 340 | 320 |
| Sludge volume after 25 min | (mL) | 350 | 270 | 270 | 270 | 330 | 320 | 300 |
| Sludge volume after 30 min | (mL) | 330 | 260 | 260 | 260 | 310 | 300 | 290 |
| Sludge volume index (SVI) | (%/mg) | 147 | 96 | 93 | 91 | 116 | 111 | 106 |
| SVI reduction respectively to | | | 34% | 37% | 38% | 21% | 24% | 28% |
| jar without chemicals | | | | | | | | |
| SVI reduction respectively to | | | 9% | 12% | 14% | | | |
| jar with FeCl₃ at (Me:P 4.3) | | | | | | | | |

TABLE 14

| | | | CeCl₃ | | | FeCl₃ | | |
|---|---|---|---|---|---|---|---|---|
| | | No addition | Molar Me:P | | | Molar Me:P | | |
| | | of chemical | 2 | 3 | 3.5 | 3.5 | 3.7 | 4.3 |
| Time to 95% settling | (min) | 23 | 12 | 13 | 14 | 23 | 21 | 19 |
| Time saving respectively to jar | | | 49% | 42% | 38% | −2% | 7% | 16% |
| without chemical | | | | | | | | |
| Time saving respectively to jar | | | 46% | 38% | 34% | | | |
| with FeCl3 (Me:P 4.3) | | | | | | | | |

Conclusions

The results presented in Table 13 show that, using activated sludge from a bioreactor, the use of phosphorus-binding chemicals in accordance with the inventive method reduces the SVI by 34 to 38% for cerium trichloride and by 21 to 28% for iron trichloride.

The results presented in Table 14 with regard to time to 95% settling show that the impacts of the two chemicals used (cerium trichloride and iron trichloride) differ greatly. Hence, the significant temporal reduction achieved using cerium trichloride cannot be attained when iron trichloride is used. More particularly, the addition of cerium trichloride to activated sludge in accordance with the inventive method reduces the time to 95% settling by 38 to 49% with respect to sludge with no chemical addition. In the same context, the addition of cerium trichloride to activated sludge in accordance with the inventive method reduces the time to 95% settling by 34 to 46% with respect to sludge containing iron at a molar Me:P ratio of 4.3.

Conclusively, the significant reduction as regards SVI and time to 95% settling enabled through addition of phosphorus-binding compounds, in particular cerium trichloride, to activated sludge opens for reduction in size of the basin (bioreactor) used. Obviously, the investment cost associated with construction or retrofit of the basin (bioreactor) may be reduced accordingly.

### Feasible Modifications of the Invention

The invention is not limited only to the embodiments described above and shown in the drawings, which primarily have an illustrative and exemplifying purpose. This patent application is intended to cover all adjustments and variants of the preferred embodiments described herein, thus the present invention is defined by the wording of the appended claims and the equivalents thereof. Thus, the equipment may be modified in all kinds of ways within the scope of the appended claims.

It shall also be pointed out that all information about/concerning terms such as above, under, upper, lower, etc., shall be interpreted/read having the equipment oriented according to the figures, having the drawings oriented such that the references can be properly read. Thus, such terms only indicates mutual relations in the shown embodiments, which relations may be changed if the inventive equipment is provided with another structure/design.

It shall also be pointed out that even thus it is not explicitly stated that features from a specific embodiment may be combined with features from another embodiment, the combination shall be considered obvious, if the combination is possible.

Throughout this specification and the claims which follows, unless the context requires otherwise, the word “comprise”, and variations such as “comprises” or “comprising”, will be understood to imply the inclusion of a stated integer or steps or group of integers or steps but not the exclusion of any other integer or step or group of integers or steps.

1.-26. (canceled)

27. A method for treating wastewater in a basin by using a binding compound to aggregate a phosphorus-containing substance present in said wastewater, wherein the binding compound comprises a coagulant, said method comprising at least the step of:
executing a reaction phase in said basin, said reaction phase comprising a biological treatment phase and a subsequent chemical treatment phase, the chemical treatment phase comprising the substeps of:
a) mixing the wastewater while injecting a predetermined dose of the binding compound into the basin, the binding compound being injected at a location in which the speed of the wastewater is equal to or more than 0.5 m/s in order for the binding compound to contact and coagulate the phosphorus-containing substances, wherein the injection of the dose of the binding compound into the basin is performed during a time period equal to or more than a time period required to accomplish two mixing turnovers of the wastewater and equal to or less than a time period required to accomplish seven mixing turnovers of the wastewater, and
b) mixing the wastewater such that an average speed of the wastewater in the basin is equal to or more than 0.1 m/s and equal to or less than 0.4 m/s, in order to flocculate the coagulated phosphorus-containing substance.

28. The method according to claim 27, wherein the mixing in substep a) is executed by at least one mechanical mixer present in the basin.

29. The method according to claim 28, wherein the binding compound is injected in proximity to said at least one mechanical mixer, at a pressure side of the at least one mechanical mixer.

30. The method according to claim 27, wherein the mixing in substep b) is executed by an aerator arrangement.

31. The method according to claim 27, wherein the injection of the dose of the binding compound into the basin is performed during a time period equal to a time period required to accomplish about five mixing turnovers of the wastewater.

32. The method according to claim 27, wherein the dose of the binding compound is dependent on a concentration of phosphorus-containing substances to be coagulated during the chemical treatment phase and is determined based on a concentration of nitrogen-containing substances in influent wastewater (C_{N}, influent) and based on a level of biodegradable carbon in the basin.

33. The method according to claim 32, wherein the dose of the binding compound is dependent on the concentration of phosphorus-containing substances to be coagulated during the chemical treatment phase and is determined based on a concentration of ammonium in the influent wastewater (C_{NH4 influent}) and based on the level of biodegradable carbon in the basin.

34. The method according to claim 33, wherein the correlation between the phosphorus concentration of the influent wastewater (C_{P, influent}) and the concentration of ammonium in the influent wastewater (C_{NH4, influent}) is equal to or less than 1:2 and equal to or more than 1:8, respectively.

35. The method according to claim 32, wherein phosphorus concentration of the liquid in the chemical treatment phase (C_{P, chemical}) is determined by subtracting target phosphorus concentration in the effluent (C_{P,target,effluent}) and phosphorus concentration in the biological treatment phase (C_{P, biological}) from phosphorus concentration in the influent (C_{P, influent}) in which (C_{P,target,effluent}) is the target level of the phosphorus concentration of the effluent wastewater and (C_{P, biological}) is a concentration reflecting phosphorus uptake (P uptake) uptake) during the biological treatment phase.

36. The method according to claim 27, wherein the coagulant is a salt.

37. The method according to claim 27, wherein the coagulant comprises a rare earth ion.

38. The method according to claim 37, wherein said rare earth ion is a cerium ion.

39. The method according to claim 38, wherein the coagulant is cerium trichloride (CeCl₃).

40. The method according to claim 27, wherein said basin comprises a first section in which the influent wastewater is received and a second section in which the reaction phase takes place.

41. The method according to claim 40, wherein the binding compound is added to the wastewater in the second section of the basin.

42. The method according to claim 40, wherein a time period required to accomplish a mixing turnover is determined with respect to the content of the second section of the basin.

43. The method according to claim 27, wherein the duration of the mixing in substep a) is equal to or more than 10 minutes and equal to or less than 30 minutes.

44. The method according to claim 27, wherein the duration of the mixing in substep b) is equal to or more than 10 minutes and equal to or less than 30 minutes.

45. The method according to claim 27, said method further comprising the step of:
executing a settling phase to allow the flocculated phosphorus-containing substances to settle in the basin such that clear wastewater is obtained at a top of the basin and an activated sludge layer is formed at a bottom of the basin.

46. The method according to claim 45, wherein a duration of the settling phase is equal to or more than 30 minutes and equal to or less than 90 minutes.

47. The method according to claim 45, said method further comprising the step of:
executing an extraction phase, in which the clear wastewater is discharged from the basin as effluent wastewater.

48. The method according to claim 45, wherein a portion of the activated sludge layer is removed from the basin.

49. The method according to claim 47, wherein the duration of the extraction phase is equal to or more than 30 minutes and equal to or less than 90 minutes.

50. The method according to claim 27, wherein the basin receives the influent wastewater at least during the biological treatment phase.

51. The method according to claim 27, wherein the coagulant being injected into the basin is dissolved in a liquid.

52. The method according to claim 27, wherein said basin is part of a Sequential Batch Reactor (SBR).
